(19) United States
(12) Patent Application Publication
(10) Pub. No.: US 2026/0284542 A1
(43) Pub. Date: Sep. 24, 2026

(54) CHILD SAFETY ANATOMY EDUCATION DEVICE AND TEACHING METHOD

(71) Applicants: John Schneider, Bridgeville, PA (US); Grace Schneider, Bridgeville, PA (US)

(72) Inventors: John Schneider, Bridgeville, PA (US); Grace Schneider, Bridgeville, PA (US)

(21) Appl. No.: 19/574,286

(22) Filed: Mar. 21, 2026

Related U.S. Application Data
(60) Provisional application No. 63/775,700, filed on Mar. 21, 2025.

(51) Int. Cl. A63H 3/00; A63H 3/02; A63H 3/28; A63H 3/52; G09B 5/04; G09B 23/30

(52) U.S. Cl. CPC A63H 3/003; A63H 3/28; A63H 3/52; G09B 5/04; G09B 23/30; A63H 3/02; A63H 2200/00

(57) ABSTRACT

This application discloses a teaching tool and method designed to engage children of various abilities, having adjustable male and female external body parts and concealed switches in “no-touch (or private) zones,” which when touched, induce a pre-recorded response to be emitted in a child-like voice to indicate that the doll should no longer be touched in that particular area. The voice responses can include multiple languages. The adjustable male and female external body parts correspond to the anatomy of children from early intervention/pre-school through twelfth grade.

### CROSS-REFERENCE TO RELATED APPLICATIONS

This application relates to U.S. Provisional Application Ser. No. 63/775,700 of the same title filed on Mar. 21, 2025, as a non-provisional utility application of the same invention and, to the fullest extent allowable, claims the benefit and priority of the same.

### BACKGROUND OF THE INVENTION

This patent application generally relates to a specially adapted doll to be used as a teaching device to educate and teach children about their anatomy to help prevent child groping and molestation.

Using the device to elucidate the method, children will be taught the difference between normal caregiving and assistance (i.e. bathing or dressing by parent) and inappropriate touching or molestation. In addition, the method will teach children about resources and avenues for help if groped or attacked.

This provisional patent application describes generally using a male or female doll as a physical representation of a child's body, having tactile switches under molded, anatomically correct parts of a doll's body, corresponding to certain parts of a child's body, wherein when the doll is touched in certain areas a digital sound chip provides human auditory voice feedback to educate the child on what to say if someone touches them in a similar area of their body without prior consent.

Various types of anatomical dolls and educational toys have been introduced to the marketplace in an effort to display some form of human anatomy or enlighten young minds about other, at times, complicated, topics in science or society at large. What is needed is an interactive, responsive, anatomically correct doll that can be used by children of several abilities and disabilities to learn the importance of and the vocabulary related to advocating for themselves against unwanted touching, groping, or any other manner of inappropriate contact.

Child abuse is not caused by a single factor, and it may take many forms, such as neglect, physical abuse, verbal abuse, and sexual violence. Educating children as concisely and directly as possible through the use of an anatomically relatable device or apparatus is needed to help inform and equip children with the tools and language necessary to support their growth and development free from the trauma of unwanted physical touching.

While parents and guardians may mean well, child abuse is far more prevalent than many individuals realize. In addition, and unfortunately, a child is more likely to be abused by a parent or close relative than a stranger. Even with the best of intentions, sheltering a child is not the best way to prepare them to advocate for themselves and identify what to say or do if they are ever in a situation with any adult or child who is attempting to touch them inappropriately. The lessons distilled through use of the invention carry forward into adulthood and are essential lessons that all children must grasp in order to instill in them an earnest understanding of what is inappropriate behavior.

The development of a child's mind, body, self-esteem, and world perspective cannot rely on good intentions alone. Child abuse is also prevalent because the locations where it occurs may not be otherwise menacing. Abuse often happens in places where the child was supposed to be or where they should feel safe: at home, school, church, on the playground, or at a friend's house, to name a few. Assisting children by supporting their understanding of their own power is essential. (https://preventchildabuse.org/what-we-do/child-sexual-abuse-prevention/).

An international problem, such as child abuse, needs an equally universal intervention. Safe play can turn into unsafe play in a matter of moments. Thinking that there is a magic time to prepare children for incidents that may never happen or may never be detected is not an effective way to prepare children to identify inappropriate behavior around them. Many child abuse advocacy groups spread awareness and provide services, often to deal with the effects of trauma. While helpful, these services do not serve the purpose intended by the presently claimed invention. The invention seeks to be a standard purchase like a baseball glove, or ball, or any other children's doll. Therefore, the invention hopes to serve as a preventive measure with the goal of exposing children to their own power at an early age.

It is estimated that a child as young as two years old can say between 200 and 300 words in addition to being able to name some body parts. The education about their bodies, their boundaries, and their independence should start as early as possible to ensure they learn the appropriate measure of physical touch before their concept of permissible actions is skewed or impacted by the bad intentions of another child or adult.

The current field of the invention does not readily offer a similar device, method, or apparatus that is focused on identifying and demonstrating inappropriate touch in a way that is understandable to children and presented with an effort to make the education and the lessons seamless. A swift response is the goal and the invention is designed to teach this method thusly.

### SUMMARY OF THE INVENTION

It is estimated that one in four girls and one in thirteen boys in the United States experience child abuse and one billion children globally experience sexual violence. If left untreated, a child who experiences abuse can suffer from long-term complications ranging from mental health problems, social and behavioral disorders, and physical health problems such as infections and other medical complications. The impact of abuse may not always be visible or readily identifiable to a concerned third-party. (https://www.cdc.gov/child-abuse-neglect/about/about-child-sexual-abuse.html).

What is needed is a device that can support the growth of children's confidence in themselves as advocates for their bodily integrity. What is also needed is a method that allows a child to distinguish without hesitation between good and bad touch. This provisional patent application is based on a desire to consolidate the need for education and an interactive model related to teaching male and female children, sighted and blind, about their capacity to object to the actions of an individual who may be harming them.

The doll provides a physical representation of a human body. The doll will have a female and male version to enrich the experience for the child at play. Voice recordings are made and ultimately saved onto a digital sound board. The sound board is modified to have multiple switches that can activate the doll voice. The switches are placed behind molded regions of the doll's body, in “no touch zones.” The “no touch zones” are placed in the corresponding intimate areas of the doll, such as the front and rear bottom of the male doll, and the front bottom, rear bottom, and chest area of the female doll.

The voice recordings are also saved in multiple languages to suit the needs of more children. The soundboard and switches are attached to the dolls body and concealed by fabric that adorns the doll like a leotard. The outer fabric suit contains a zipper that conceals the electronic components.

The doll is designed to allow teachers of blind and sighted students to instruct them as to what is an appropriate and non-appropriate area of the male and female body for human interaction. Non-sighted children cannot learn visually from charts or graphs. Human contact with sighted or blind children would eviscerate the very concept sought to be taught. The doll allows for tactile and auditory means of educating students on this important area of development.

Many intervention measures or social aids, if employed at all, are often done so too late, after abuse has happened or continued for a period of time. These interventions are not preventive measures. The invention seeks to popularize the idea of teaching children about how to be on alert and in control, to the best of their ability, over their bodies. The invention seeks to bring child anatomical autonomy and safety to the forefront of discussions as well as assist parents who may desire to educate their children in this way, but lack a tool that can be used apart from the child themselves.

The method is suitable for children possessing general motor skills and basic language skills. The introduction of the invention to a child is expected to yield natural curiosity and familiarity as the invention is designed to mimic a child's appearance and attributes. The invention is not designed to be overly sensitive but instead responsive to intentional and consistent contact sufficient to activate the electronic components within the “no-touch” zones.

One method is eliciting an audible response when a “no-touch zone” switch is triggered coupled with guided instruction from a parent or teacher. Another method is eliciting an audible response when a “no-touch zone” switch is triggered and allowing the child to interact and learn independently.

These methods are suitable for teaching both sighted and non-sighted children learn about their anatomy and their “no-touch zones” due to the auditory and tactile feedback.

The invention has interchangeable external body suits that mimic the anatomical development of children at different age ranges to encourage a realistic and mature understanding of the child's body without the need to invade their privacy for the purpose of the educational aspect. Without jeopardizing the severity of the topic, the doll is still a toy and should be integrated into play just as any other new toy. The interchangeable anatomical suits also demonstrate and emphasize the importance of teaching all young people, early intervention/pre-school children through teenagers, about abuse and their capacity to intervene. The external body suits may take the form of an “art smock,” “Swedish apron,” or other similar play clothing. Such clothing may additionally be of the size and fix suitable for the children to wear, demonstrating the corresponding anatomical “no-touch zones” on their own bodies.

### BRIEF DESCRIPTION OF THE DRAWINGS

FIG. 1 is a front overhead view of an embodiment of the invention from the rear and a cutout figure showing the internal electronic components.

FIG. 2 is a front overhead view of an embodiment of the invention from the front.

FIG. 3 is a front overhead view of an embodiment of the invention from the rear with a transparency showing one placement of the internal electronic mechanism.

### DETAILED DESCRIPTION OF EXEMPLARY EMOBODIMENTS

It should be understood that this application is not limited to the details or methodology set forth in the following descriptions or illustrated in the figures. It should also be understood that the phraseology and terminology employed herein is for the purpose of description only and should not be regarded as limiting.

One embodiment of the invention is a teaching device for teaching anatomy comprising a doll having anatomical parts, at least one sensor, a processing unit, a speaker, and a battery; wherein the sensor, speaker, and battery are contained within the doll; and wherein the sensor corresponds with an anatomical part of the doll that can be engaged externally and causes the emission of a sound from the speaker when engaged.

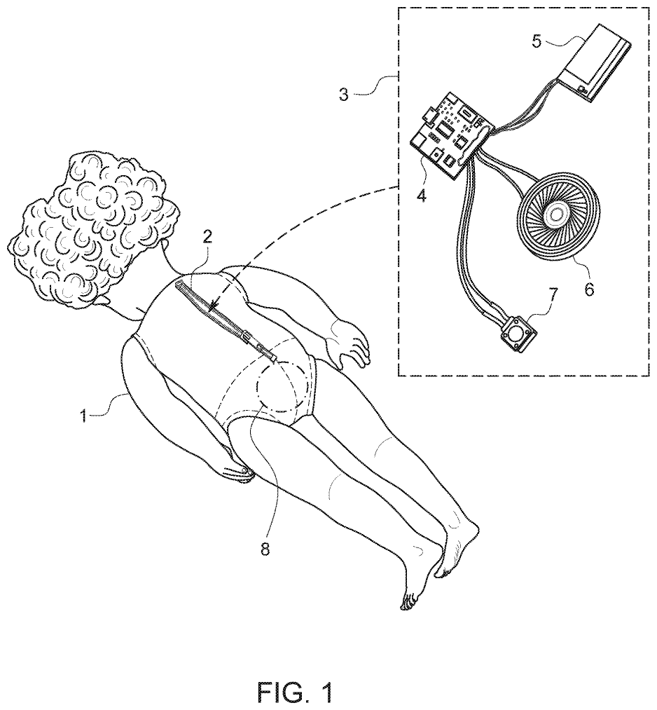

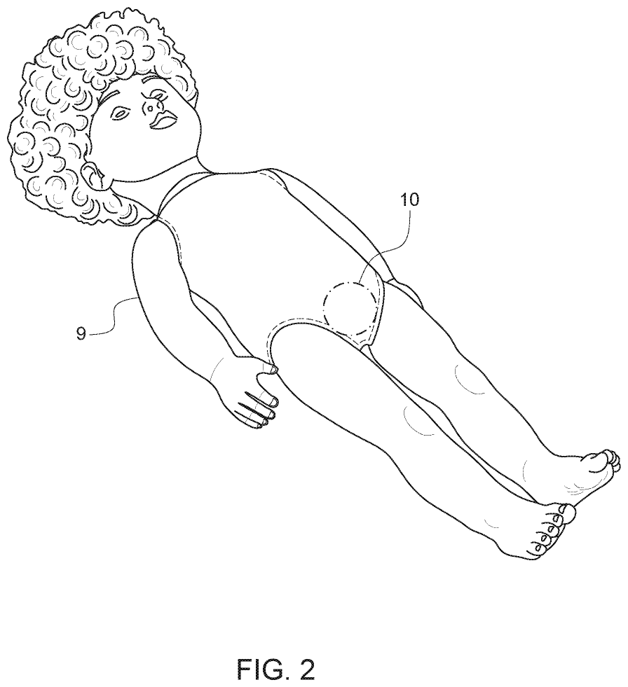

As shown in FIG. 1, the internal parts group 3 may be enclosed within the doll 1 with a zipper 2. Such internal parts may comprise a processing component 4, a rechargeable battery 5, a speaker 6, and at least one sensor 7. Such sensor 7 is placed internally so it may be engaged externally in a specific “no-touch zone” 8 or 10, as shown in FIG. 2.

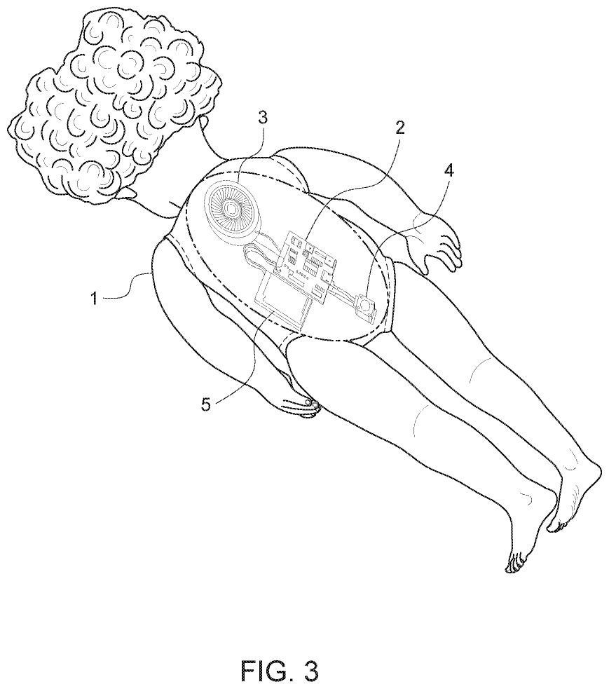

As shown in FIG. 3, the internal parts group 3 is housed within doll 1. These electronic components are hidden from view so as to not confuse the student about their own anatomy.

In other embodiments, zipper 2 may be other means of enclosure, such as but not limited to buttons, snaps, or laces.

In one embodiment, touch sensors or switches are located in “no-touch zones” on the doll. In at least one embodiment, the touch sensors are placed under molded body parts corresponding to the “no-touch zones.”

In another embodiment, a digital sound board and switches that correspond to different areas of the doll are externally attached to the doll's back and concealed with additional fabric.

In another embodiment, the sound recordings provide audio feedback in different pre-programmed languages.

In another embodiment, there is an anatomically male doll and an anatomically female doll. Such anatomical dolls may be anatomically correct with high detail to aid sighted, non-sighted, and low vision children learn.

In another embodiment, there is a removable external suit that can be placed and removed from the doll and the suit corresponds to the anatomy of a male or female child through different stages of development from pre-school through twelfth grade. Such stages may relate to specific age groups or bands and demonstrate typical body development at that stage.

In another embodiment, there is a rechargeable battery housed with the switchboard, speakers, and other electronics beneath the external fabric suit. The external fabric suit contains a zipper or other means of enclosure that permits access to the electronic components of the invention.

In another embodiment, the touch sensors or switches are placed in “no-touch zones” of the male and female doll; the front and back rear of the male doll and the front chest, front and back rear of the female doll. When either sensor is activated an audible human response is emitted protesting the contact. The messages are prerecorded and may vary or be the same for all switches.

In another embodiment, the doll has hair and facial characteristics that mimic a human child.

In other embodiments, the invention takes different forms and sizes corresponding to different stages of development from pre-school through twelfth grade and demonstrates typical body development at that stage.

In other embodiments, the invention may be anatomically intersex or any possible human anatomy.

In other embodiments, the auditory components are paired with haptic components to provide physical feedback to aid low-hearing or deaf students.

In other embodiments, the invention may take the form of a toy-type doll that is suitable and appealing to the target aged child. Such doll may or may not have detailed anatomy, but may nonetheless contain the sensors and feedback mechanisms described herein to demonstrate the “no-touch zones.”

In other embodiments, the invention may take the form of a non-human doll that is suitable and appealing to the target aged child, such as a teddy bear, a notable non-human children's character, or a stuffed dog. Such doll may or may not have detailed anatomy, but may nonetheless contain the sensors and feedback mechanisms described herein to demonstrate the “no-touch zones.”

The device disclosed herein may be constructed of any suitable material or materials and shall not be thus limited.

Additionally disclosed herein is a method of teaching anatomy using any embodiment of the device disclosed herein wherein a student is given auditory, visual, physical, and/or haptic feedback when a certain anatomical part of the device is touched to gain greater awareness of their anatomy and how to respond if they are touched in a similar area on their own body.

In embodiments of the method disclosed herein, the student is in the range of early intervention or pre-school through high school aged.

In some embodiments of the device and method disclosed herein, the student is an adult with special needs.

In embodiments of the method disclosed herein, the feedback is further contextualized with other information such as the need for hygiene and the appropriateness of certain touching by a parent or care giver in aid of such hygiene.

In embodiments of the method disclosed herein, the student is further instructed on how to appropriately react to an inappropriate touch either in the moment or after the fact through self defense means and/or by alerting responsible guardians and authorities.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Moreover, in the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the detailed description are hereby expressly incorporated into this detailed description, with each claim standing on its own as a separate embodiment of the invention.

We claim:

1. A child safety education device comprising:
a doll body having a plurality of anatomically represented regions corresponding to a human child's body;
at least one sensor positioned within the doll body at a location corresponding to a designated private zone of a human child's body;
a processing unit in communication with the at least one sensor;
a speaker in communication with the processing unit; and
a power source;
wherein at least one sensor, the processing unit, the speaker, and the power source are housed within the doll body and concealed from external view via a closeable enclosure;
wherein at least one sensor is configured to detect external contact at the private zone; and
wherein the processing unit is configured to cause the speaker to emit an auditory response upon detection of external contact at the private zone.

2. The child safety education device of claim 1, further comprising a haptic feedback component in communication with the processing unit, wherein the processing unit is further configured to cause the haptic feedback component to emit a physical vibration upon detection of external contact at the private zone.

3. The child safety education device of claim 1, wherein the closeable enclosure for the internal components comprises at least one of a zipper, buttons, snaps, or laces, and wherein the closeable enclosure is concealed beneath an external fabric suit worn by the doll body.

4. The child safety education device of claim 1, wherein at least one sensor is a tactile switch positioned internally beneath a molded anatomical region of the doll body corresponding to a private zone.

5. The child safety education device of claim 1, wherein the doll body is anatomically male, and wherein a first sensor positioned at a front pelvic private zone and a second sensor positioned at a rear pelvic private zone.

6. The child safety education device of claim 1, wherein the doll body is anatomically female, and wherein a first sensor positioned at a front pelvic private zone, a second sensor positioned at a rear pelvic private zone, and a third sensor positioned at a chest private zone.

7. The child safety education device of claim 1, wherein the doll body is anatomically intersex or otherwise represents a non-conventional human anatomy.

8. The child safety education device of claim 1, wherein the doll body takes the form of a non-human character, a stuffed animal, or a toy figure, and wherein at least one sensor and the speaker are positioned and configured to demonstrate at least one private zone corresponding to a human child.

9. The child safety education device of claim 1, wherein the auditory response comprises a verbal protest of the contact, an identification of the anatomical area that was touched, and an instruction to the child on how to respond to unwanted touching.

10. The child safety education device of claim 1, further comprising a removable external body suit configured to be worn over the doll body having anatomical representations of a child at a specified stage of development.

11. The child safety education device of claim 1, wherein the doll body has a head and face with hair and facial characteristics similar to a human child at a specified stage of development.

12. A child safety education system comprising:
an anatomically representative doll body;
a removable external body suit configured to be worn over the doll body, the external body suit representing the anatomical development of a child at a specified stage of development;
at least one touch sensor positioned within the doll body at a location corresponding to a private zone;
a digital sound processing component in communication with the sensor or sensors;
a speaker in communication with the digital sound processing component, the speaker configured to emit a pre-recorded response upon activation of at least one touch sensor; and
a rechargeable power source;
wherein the touch sensor, the digital sound processing component, the speaker, and the rechargeable power source are collectively concealed within the doll body by a closeable enclosure.

13. The child safety education system of claim 12, wherein the removable external body suit is one of a plurality of interchangeable external body suits, each interchangeable external body suit representing a different anatomical stage of development ranging from early intervention or pre-school through twelfth grade.

14. The child safety education system of claim 12, wherein the removable external body suit is sized and configured to be worn by a child, thereby demonstrating the corresponding private zones on the child's own body.

15. The child safety education system of claim 12, wherein the doll body takes the form of a non-human character, a stuffed animal, or a toy figure, and wherein at least one sensor and the speaker are positioned and configured to demonstrate at least one private zone corresponding to a human child.

16. A method of teaching child anatomy safety comprising:
providing a doll having at least one sensor located within the doll body at a position corresponding to a private zone of a human child's body;
presenting the doll to a student;
detecting, via the sensor, physical contact applied externally to the private zone of the doll; and
emitting, via a speaker housed within the doll body, a pre-recorded auditory response upon detection of physical contact, thereby communicating to the student an appropriate response to unwanted touching of a corresponding area of the student's own body.

17. The method of claim 16, further comprising contextualizing the auditory response by distinguishing, through the pre-recorded content or accompanying instruction, between appropriate caregiving contact and inappropriate touching.

18. The method of claim 16, further comprising instructing the student, following activation of the sensor, on appropriate self-advocacy responses, including alerting a responsible guardian or authority figure.

19. The method of claim 16, wherein the student is a non-sighted or low-vision child, and wherein the auditory response and tactile engagement with the doll body provide a non-visual means of learning anatomical boundaries.

20. The method of claim 16, wherein the student is an adult with special needs, and wherein the auditory response is tailored to communicate age-appropriate anatomical safety education.
